(19) United States
(12) Patent Application Publication
(10) Pub. No.: US 2011/0094807 A1
(43) Pub. Date: Apr. 28, 2011

(54) ELECTRIC DRIVE SYSTEM FOR PASSIVE VEHICLE

(76) Inventors: Steve Pruitt, Sandy, UT (US); Alden Rix, Sandy, UT (US)

(21) Appl. No.: 12/912,572

(22) Filed: Oct. 26, 2010

Related U.S. Application Data
(60) Provisional application No. 61/254,948, filed on Oct. 26, 2009.

(51) Int. Cl. B60K 1/02; B23P 17/00

(52) U.S. Cl. 180/65.6; 29/401.1

(57) ABSTRACT

One embodiment of an electric drive system includes first and second gear assemblies coupled to a hollow axle tube, and first and second electric motors respectively coupled to the first and second gear assemblies. Further, the electric drive system includes first and second drive axles positioned within the hollow axle tube. The first drive axle includes a first end portion coupled to a first wheel and a second end portion coupled to the first gear assembly. Similarly, the second drive axle includes a first end portion coupled to a second wheel spaced-apart from the first wheel and a second end portion coupled to the second gear assembly. Actuation of the first electric motor rotates the first drive axle and first wheel via the first gear assembly and actuation of the second electric motor rotates the second drive axle and second wheel via the second gear assembly.

### CROSS-REFERENCE TO RELATED APPLICATION

This application claims the benefit of U.S. Provisional Patent Application No. 61/254,948, filed Oct. 26, 2009, which is incorporated herein by reference.

### FIELD

The present disclosure is related generally to a vehicle propulsion system, and more specifically to an electric drive system for a passive vehicle.

### BACKGROUND

Many conventional wheeled vehicles are passive. As defined herein, a passive vehicle is a vehicle that includes only passive or non-driven axles or at least one passive or non-driven axle. One example of a passive vehicle is the trailer portion of a tractor-trailer vehicle used for the transportation of goods. The tractor portion of a tractor-trailer vehicle also can be a passive vehicle where the tractor portion includes a drive axle and a dead or passive axle (e.g., a tag axle positioned rearward of the drive axle and a pusher axle positioned forward of the drive axle). Conventional tractor-trailer vehicles include a tractor powered by an internal combustion engine and a trailer pulled by the tractor. The internal combustion engine of the tractor drives an axle of the tractor to move the trailer secured to the tractor in an articulated manner. Therefore, the axles of the trailer are passive.

In an attempt to improve fuel efficiency, reduce pollution, and reduce operating costs, some tractor-trailer vehicles include drive systems coupled to the trailer to drive an otherwise passive axle of the trailer. However, such passive axle drive systems suffer from several drawbacks. For example, some known passive axle drive systems utilize a single electric motor coupled to a differential gear box, which transfers power generated by the motor to the wheels of the trailer via one or more drive shafts. In other words, the electric motor does not directly drive a drive shaft. Due to the large size and robust configuration of differential gear boxes, these passive axle drive systems tend to be expensive, complex, and heavy. Other passive axle drive systems describe an electric motor coupled to a rear axle of a trailer, but do not describe or show how the coupling is implemented. Yet other passive axle drive systems cannot be easily retrofitted onto existing trailers.

Many conventional passive axle drive systems are not self-sustaining. In other words, many systems do not include regenerative braking capability. For those conventional passive axle drive systems that do employ regenerative braking capability, the recovered energy is stored in batteries mounted to the tractor. Accordingly, such passive axle drive systems are not self-contained. For this reason, trailers equipped with conventional passive axle drive systems do not function independently of the tractor and are not interchangeable with different tractor makes and models.

Further, some passive semi-tractors with one or more passive axles adjacent a drive axle may become immobile under certain driving conditions. For example, on uneven travel surfaces, the tires of a passive axle may come to rest on an elevated localized portion of the surface resulting in the tires of the adjacent drive axle to be suspended above the surface. Because the tires of the drive axle are out of contact with the road surface, the semi-tractor is effectively stranded or immobilized.

### SUMMARY

The subject matter of the present application has been developed in response to the present state of the art, and in particular, in response to the problems and needs in the art that have not yet been fully solved by currently available electric drives for passive axles of passive vehicles. Accordingly, the subject matter of the present application has been developed to provide an apparatus, system, and method that overcomes most of the shortcomings of the prior art. For example, in one embodiment described in the present disclosure, an electronic drive system includes two electric motors each independently driving a separate wheel. The electronic drive system can be coupled directly to a vehicle's passive hollow structural axle to independently drive respective splined drive axles positioned within the hollow structural axle without the need for an intermediate differential gear box. The electronic drive system can be inexpensive, compact, and light-weight, and does not degrade the structural integrity of the trailer's passive axle design.

Further, the electronic drive system can be configured to be easily retrofitted onto existing passive vehicles.

Additionally, the electric drive system can be self-contained such that for tractor-trailer applications, the trailer can be interchangeable with different tractor makes and models.

Moreover, for passive vehicles with adjacent passive axles and drive axles, the electric drive system can be utilized to restore mobility to an immobilized passive vehicle with its passive axle tires in contact with a travel surface and drive axle tires suspended above the travel surface. More specifically, the electric drive system can be operated to move the vehicle using the passive axle tires in contact with the travel surface such that contact between the drive axle tires and the travel surface is restored.

According to one embodiment, an electric drive system for a passive vehicle having a pair of spaced-apart wheels includes a hollow axle tube positioned between the spaced-apart wheels. The electric drive system also includes first and second gear assemblies coupled to the hollow axle tube, and first and second electric motors respectively coupled to the first and second gear assemblies. Further, the electric drive system includes first and second drive axles positioned within the hollow axle tube. The first drive axle includes a first end portion coupled to a first of the spaced-apart wheels and a second end portion coupled to the first gear assembly. Similarly, the second drive axle includes a first end portion coupled to a second of the spaced-apart wheels and a second end portion coupled to the second gear assembly. Actuation of the first electric motor rotates the first drive axle and first wheel via the first gear assembly and actuation of the second electric motor rotates the second drive axle and second wheel via the second gear assembly.

According to some implementations of the electric drive system, the hollow axle tube includes first and second apertures. A portion of the first gear assembly is received within the first aperture and a portion of the second gear assembly is received within the second aperture. The electric drive system may also include first and second clamps each at least partially encircling the hollow axle tube and covering a respective one of the first and second apertures to retain the respective portions of the first and second gear assemblies within the first and second apertures.

In some implementations, the hollow axle tube of the system defines a lubricant reservoir that contains a lubricant. At least one gear of the first and second gear assemblies can be exposed in lubricant receiving communication with the lubricant in the lubricant reservoir. Each of the first and second gear assemblies can comprise a plurality of gears each having an axis of rotation, and the first and second electric motors may include a drive shaft. According to certain implementations, the hollow axle tube, axes of rotation, drive shafts, first drive axle, and second drive axle are parallel to each other. In such implementations, the first gear assembly can be housed within a first gear housing and the second gear assembly can be housed within a second gear housing, and the first and second gear housings can be fastened directly to the hollow axle tube.

According to some implementations, the first and second electric motors are positioned between the first and second gear assemblies. In yet some implementations, the first and second gear assemblies are positioned between the first and second electric motors.

The hollow axle tube can be a single continuous tube. However, in certain implementations, the hollow axle tube can include a plurality of interconnected tube sections. The system can include a first gear housing in which the first gear assembly is housed and a second gear housing in which the second gear assembly is housed. In some implementations, the first and second gear housings are coupled to the at least two interconnected tube sections. A first tube section of the at least two tube sections can be positioned between the first and second gear housings. The first gear housing can be positioned between the first tube section and a second tube section of the at least two tube sections, and the second gear housing can be positioned between the first tube section and a third tube section of the at least two tube sections.

In yet some implementations, the first and second gear housings can be secured to each other in a back-to-back configuration. A first tube section can be secured directly to the first gear housing and positioned between the first gear housing and the first wheel. A second tube section can be secured directly to the second gear housing and positioned between the second gear housing and the second wheel.

Moreover, in some implementations, each gear assembly includes a linear gear train assembly positioned within an enclosed housing fitted between flange plates at the end of the tube sections. The linear gear train assembly can be a reduction gear assembly with a final gear centered within a linear cavity of the hollow axle tube and spline fitted to a respective one of the drive axles or shafts.

In another embodiment, an electric drive system for a passive vehicle having a pair of spaced-apart wheels includes a hollow axle tube positioned between the spaced-apart wheels and secured to the trailer. The system also includes first and second gear assemblies coupled to the hollow axle tube. The first and second gear assemblies can each be a linear gear assembly. The first and second gear assemblies each includes a plurality of gears rotatable about respective axes extending parallel to the hollow axle tube. The system further includes first and second electric motors respectively coupled to each gear assembly. The first and second electric motors each includes an input/output shaft extending parallel to the hollow axle tube. The input/output shaft of the first electric motor is coupled to a first drive gear of the first gear assembly and the input/output shaft of the second electric motor is coupled to a first drive gear of the second gear assembly.

The system additionally includes first and second opposing drive axles that are positioned within the hollow axle tube and extend parallel to the hollow axle tube. In certain implementations, the drive axles are centered within (e.g., coaxial with) the hollow axle tube. The first drive axle includes a first end portion coupled to a first of the spaced-apart wheels and a second end portion coupled to a second drive gear of the first gear assembly. Similarly, the second drive axle includes a first end portion coupled to a second of the spaced-apart wheels and a second end portion coupled to a second drive gear of the second gear assembly. The second drive gears are positioned within the hollow axle tube. The system further includes an energy storage system in electrical power communication with the first and second electric motors. The energy storage system supplies electrical power to at least one of the first and second electric motors in a drive assist mode and receives electrical power from at least one of the first and second electric motors in an energy recovery mode.

In some implementations, the input/output shafts of the first and second electric motors can be parallel to, and vertically aligned with or offset to the respective first and second drive axles. According to certain implementations, the energy storage system may include at least one battery and a capacitor in electrical power transmitting communication between the at least one battery and the first and second electric motors. The energy storage system can be in electrical power communication with at least one auxiliary device of the passive vehicle in an auxiliary power mode. In application where the passive vehicle is a semi-trailer, the energy storage system can be secured to and contained entirely within the confines of the semi-trailer. According to some implementations, the energy storage system includes a power control unit that is configured to independently control actuation of the first and second electric motors.

In yet another embodiment, a method of retrofitting an existing passive vehicle that has a passive rear axle assembly with an existing hollow axle tube coupled to the trailer via a suspension assembly is described. The method includes removing the existing hollow axle tube from the suspension assembly and providing an electrically driven rear axle assembly comprising a modified hollow axle tube substantially similar to the existing hollow axle tube. The rear axle assembly includes first and second gear assemblies coupled to the modified hollow axle tube and first and second electric motors respectively coupled to the first and second gear assemblies. Additionally, the rear axle assembly includes first and second drive axles positioned within the hollow axle tube where the first drive axle includes an end portion coupled to the first gear assembly and the second drive axle includes an end portion coupled to the second gear assembly. Actuation of the first electric motor rotates the first drive axle via the first gear assembly and actuation of the second electric motor rotates the second drive axle via the second gear assembly. The method also includes coupling the modified hollow axle tube to the suspension assembly.

In certain implementations of the method, providing the modified hollow axle tube includes forming two slots into the removed existing hollow axle tube. Further, providing first and second gear assemblies coupled to the modified hollow axle tube includes inserting at least one gear of the first gear assembly within one of the two slots and inserting at least one gear of the second gear assembly within the other of the two slots.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment or implementation.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a side view of a tractor-trailer system having a passive axle assembly according to one representative embodiment;

FIG. 2 is a perspective view of a passive axle assembly of a passive vehicle according to one representative embodiment;

FIG. 3 is a partial cross-sectional perspective view of an electric drive system of the passive axle assembly of FIG. 2 according to one representative embodiment;

FIG. 4 is a perspective view of an electric drive assembly of an electric drive system according to one representative embodiment;

FIG. 5 is a partial cross-sectional rear view of a passive axle assembly according to another representative embodiment;

FIG. 6 is an exploded perspective view of the passive axle assembly of FIG. 5;

FIG. 7 is a partial cross-sectional rear view of a passive axle assembly according to yet another representative embodiment;

FIG. 8 is a perspective view of a passive axle assembly according to another embodiment; and

FIG. 9 is a schematic block diagram of an electric drive system according to one representative embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

In the following description, numerous specific details are provided to impart a thorough understanding of embodiments of the present disclosure. One skilled in the relevant art will recognize, however, that the subject matter of the present disclosure may be practiced without one or more of the specific details, or with other methods, components, materials, and so forth. In other instances, well-known structures, materials, or operations are not shown or described in detail to avoid obscuring aspects of the disclosure.

Described herein are various embodiments of an electric drive system for a passive vehicle that overcomes one or more of the limitations of conventional techniques. According to at least some embodiments, the electric drive system provides self-sustaining drive assistance to an otherwise passive axle. Generally, the electric drive system utilizes a passive axle tube to house separate drive shafts or axles each secured to respective wheels or set of wheels on opposite sides of the passive axle tube. The drive shafts are independently and directly driven by separate electric motors via separate gear assemblies and thus a differential gear box is not required. The gear assemblies extend through openings in the passive axle tube to engage the drive shafts housed in the tube. The electric drive system can be easily retrofitted to existing passive vehicles (e.g., trailers) by replacing the existing passive axle tube with the passive axle tube of the electric drive system without compromising and in most cases, if not all cases, increasing the structural integrity and performance of the passive axle. Additionally, the electric motors can be operated as generators to convert braking energy to electrical energy, which can be used to power the electric motors for drive assistance or other electrical components of the passive vehicle or other vehicles coupled to the passive vehicle. The hollow axle tube is a structural member of the passive vehicle that supports a substantial portion of the weight of the vehicle. Accordingly, the electric drive system is coupled to the hollow axle tube in a manner that does not degrade the structural integrity of the tube.

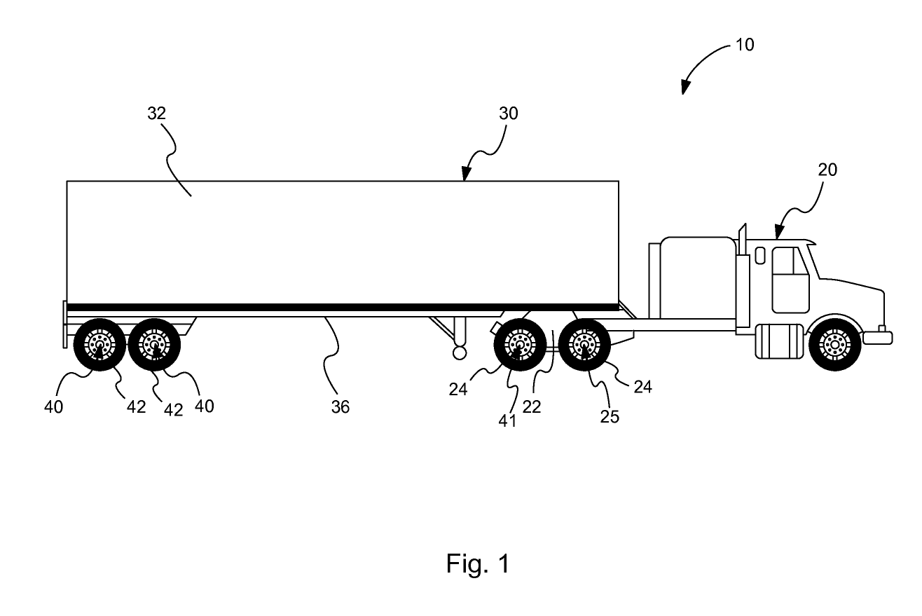

Referring to FIG. 1, a tractor-trailer system 10 or semi-trailer truck is shown according to one embodiment. The system 10 includes a tractor 20 coupled to a passive vehicle (e.g., a trailer 30) via a hitch mechanism 22 as is commonly known in the art. As defined herein, a passive vehicle is any vehicle or mode of transport that includes at least one conventionally non-driven axle. The tractor 20 includes an internal combustion engine (not shown) configured to propel the tractor by driving at least one set of rear wheels 24 of the tractor. The driven set of rear wheels 24 are coupled to a drive axle assembly 25 with one or more drive axles driven by the internal combustion engine. In some embodiments, the tractor 20 includes a passive axle assembly 41 (e.g., a tag axle assembly) positioned rearward of the drive axle assembly 25. Although not shown, a passive axle assembly 41 (e.g., a pusher axle assembly) with corresponding rear wheels 24 can be positioned forward of the drive axle assembly 25. In some implementations, the drive and passive axle assemblies can form part of a 6×2 tractor configuration. When coupled to the trailer 30, the tractor 20 is configured to move (e.g., pull or push) the trailer.

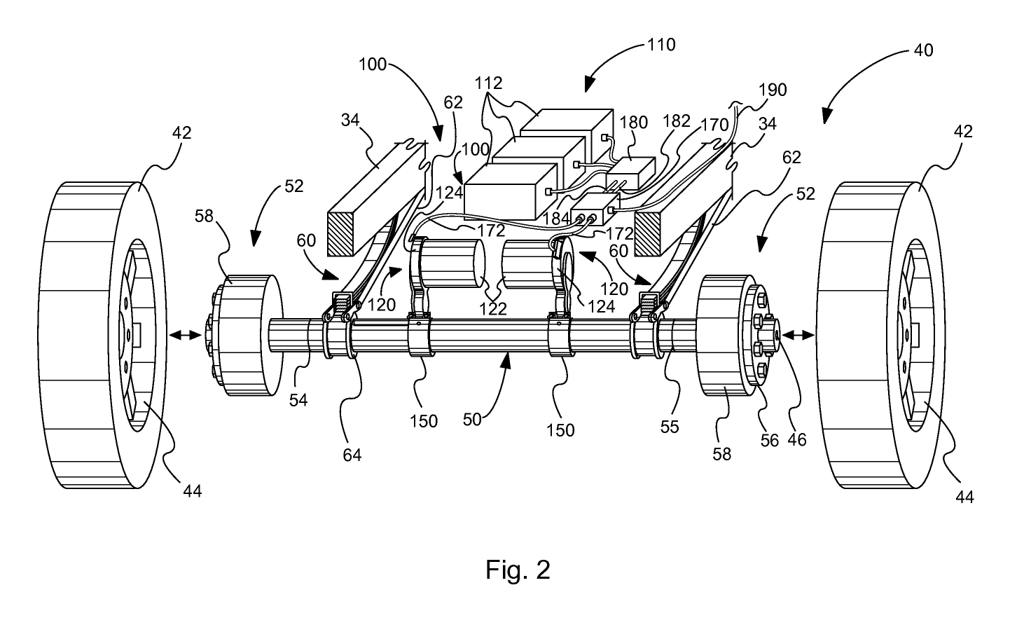

The trailer 30 includes a cargo containment area 32 supported by a pair of frame rails 34 (see FIG. 2) and associated cross-members (not shown). The frame rails 34 extend along an underside of a floor 36 of the cargo containment area. In other words, the floor 36 is supported on the frame rails 34. The trailer 30 includes at least one rear axle assembly 40 that couples the wheels 42 to the trailer. As shown, the trailer 30 includes two rear axle assemblies 40, and, in some implementations, can include less or more than two rear axle assemblies. The passive axle assembly 41 of the tractor 20 can be the same as or similar to the rear axle assembly 40 of the trailer 30. More specifically, the main components of the passive axle assembly 41 can be analogous to the main components of the rear axle assembly 40 such that the electric drive system described herein can be applied to the passive axle assembly 41 of the tractor 20 in the same or similar manner as the rear axle assembly 40 of the trailer 30. Moreover, the electric drive system described herein can be applied to other passive axle assemblies of other vehicles in the same or similar manner as the rear axle assembly 40. More specifically, the features, components, and advantages associated with the electric drive system of the present application are not limited to passive axle assemblies. However, for simplification and clarification purposes, the application will proceed to describe embodiments of the electric drive system as applied to the rear axle assembly 40 of the trailer 30.

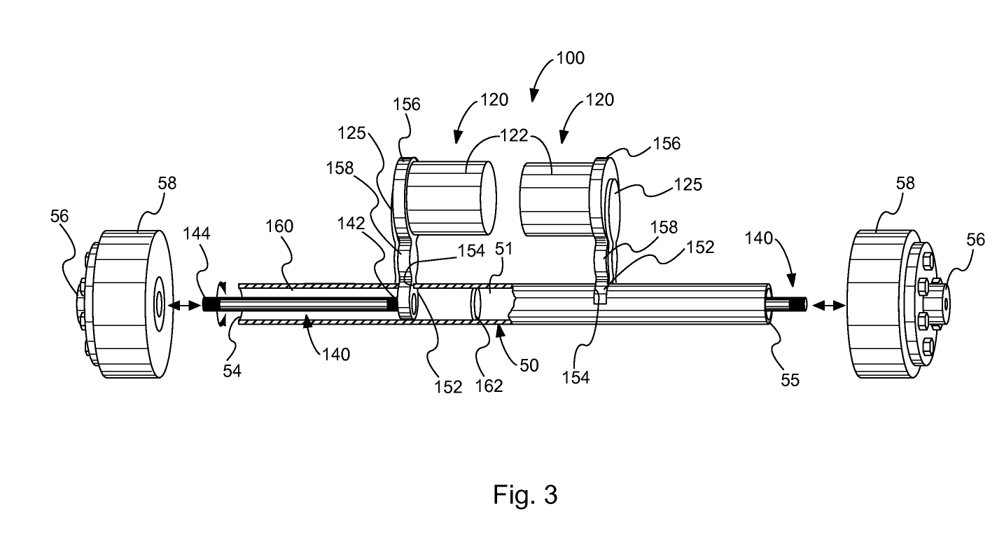

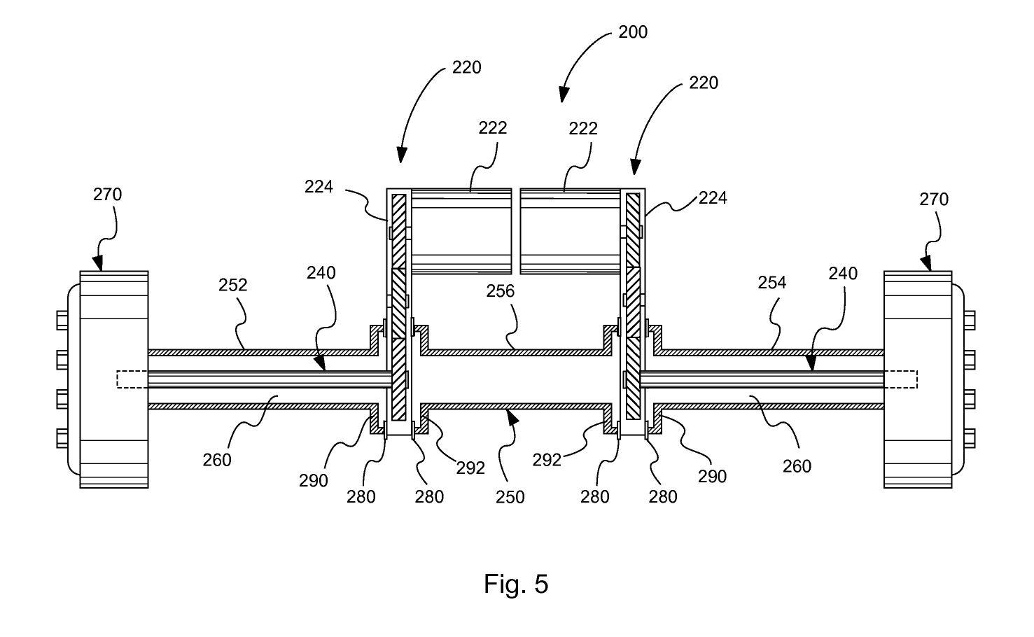

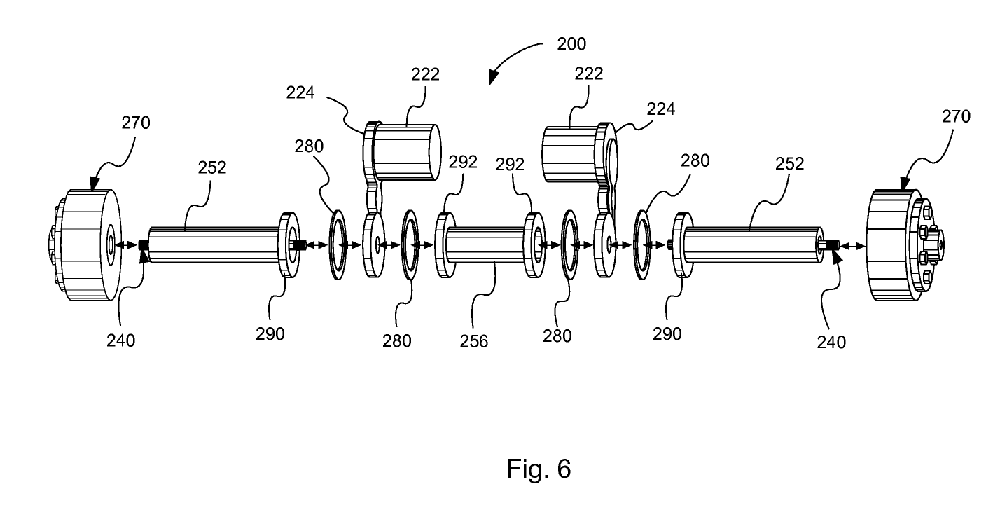

As shown in FIG. 2, the rear axle assembly 40 includes an axle tube 50 coupled to a pair of hub assemblies 52 at respective ends 54, 55 of the tube. The axle tube 50 includes a length of hollow tubing or pipe that defines an interior channel 51 (see FIG. 3). The axle tube 50 can be a single, continuous tube (as shown in FIGS. 2 and 3), or multiple tube sections coupled together (as shown in FIGS. 5 and 6). The axle tube 50 is configured to support at least a substantial portion of the weight of the trailer 30 and associated cargos or cargo. Accordingly, the axle tube 50 has a wall thickness and inner diameter, and is made from a high-strength material that is sufficient to support a maximum weight of the trailer and cargo. For example, in certain implementations, the axle tube 50 has a wall thickness between approximately 12.7 mm and approximately 19.0 mm, an inner diameter of approximately 5 inches, and is made from steel or a steel alloy.

The hub assemblies 52 couple the wheels 42 to the axle tube 50. More specifically, the hub assemblies 52 each include a hub 56 configured to mate with a rim 44 of a respective wheel 42. In certain implementations, the hub 56 includes a plug or cap 46 sealing a conduit (not shown) from the hub to an interior of the axle tube 50. The hub assemblies 52 also include a braking mechanism 58 configured to resist and ultimately stop rotation of the wheels 42 and hubs 56 relative to the axle tube 50. The braking mechanism 58 can be any of various braking mechanisms known in the art, such as electric, hydraulic, or air shoe/drum brakes, and disc brakes, without departing from the essence of the invention.

The axle tube 50 is secured to the frame rails 34 of the trailer 30 via suspension members 60 and connecting rods 62. The suspension members 60 can include a plurality of leaf springs that extend from a location forward of the axle tube 50 to a location rearward of the axle tube. The leaf springs can be secured to the axle tube 50 by a perch bracket 64 secured to the axle tube 50 as shown in FIG. 2. Each connecting rod 62 is pivotally coupled at one end to the perch bracket 64 and pivotally coupled to frame rail 34 at a location upstream or downstream of the axle tube. In FIG. 2, the portion of the leaf springs, connecting rods 62, and frame rails 34 rearward of the axle tube 50 have been removed for convenience in showing the details of the rear axle assembly 40.

One or both of the rear axle assemblies 40 includes an electric drive system 100 for selectively driving the wheels 42 and regenerating an energy storage system 110. The electric drive system 100 includes a pair of electric drive assemblies 120 each configured to separately drive a respective wheel 42. Each electric drive assembly 120 includes an electric motor 122 coupled to a gear housing 124. In certain implementations, the electric motor 122 is contained within a housing to protect and secure the motor.

The electric motor 122 can be any of various electric motors know in the art without departing from the essence of the invention. Preferably, however, the electric motor 122 is any motor capable of functioning as a kinetic energy recovery system (KERS) motor. In one embodiment, the electric motor 122 is a 3-phase asynchronous electromagnetic induction motor capable of providing a peak power range between about 35 kw and about 45 kw. In other embodiments, however, the electric motor 122 can be capable of providing peak power greater than 45 kw depending at least partially on the amount of torque the assembly 40 can sustain. In some embodiments, the electric motor 122 can be any of various other types of electric motors, such as brushless DC motors. The electric motor 122 is powered by one or more batteries 112 of the energy storage system 110 and includes a thermal management or dissipation system, such as a natural air cooling duct system fitted to the trailer 30, a liquid intercooler system, or a system utilizing advanced heat sink technology (e.g., using the frame rails as heat sinks).

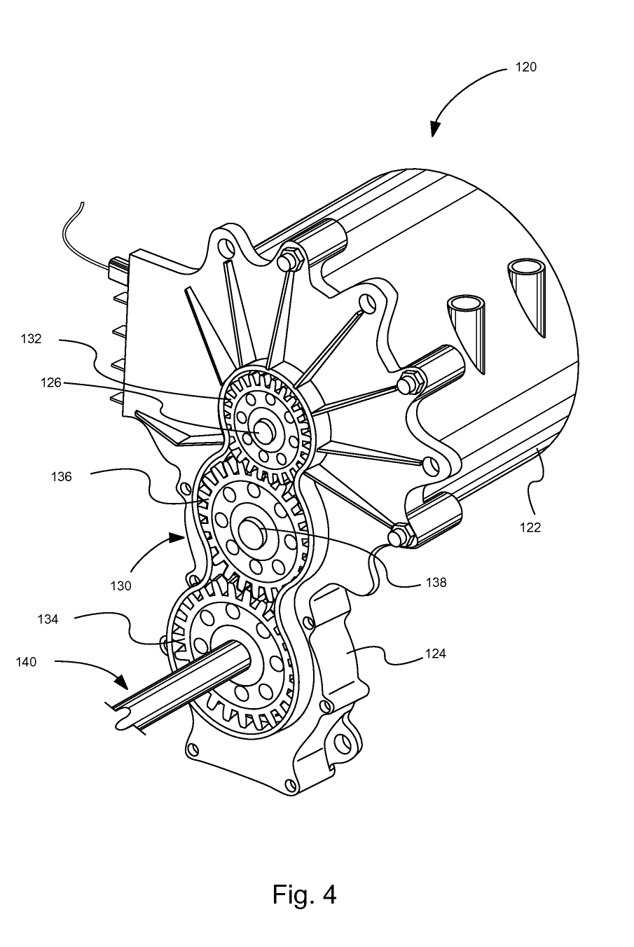

Referring to FIG. 4, the electric motor 122, which in the illustrated embodiment is a housing 122 that contains an electric motor (not shown), includes an input/output shaft 126 having a central axis. The electric motor 122 is secured to the gear housing 124 such that the input/output shaft 126 extends at least partially into the housing. In certain embodiments, the electric motor 122 is secured to the gear housing 124 using any of various fastening techniques, such as a nut and bolt arrangement. The portion of the input/output shaft 126 within the gear housing 124 engages a gear assembly 130 retained by the housing.

The gear assembly 130 includes a set or train of gears 132, 134, 136, which can be in a linear or planetary arrangement. The gear 132 is a motor gear to which the input/output shaft 126 of the electric motor 122 is engaged. The engagement between the shaft 126 and motor gear 132 facilitates co-rotation between the shaft and the motor gear. In some implementations, an end portion of the input/output shaft 126 includes splines that matingly engage corresponding splines formed along a central opening of the motor gear 132. The gear 134 is an axle drive gear to which a respective one of two axles 140 (see, e.g., FIG. 3) is engaged. The engagement between the axle 140 and the axle drive gear 134 facilitates co-rotation between the axle and the axle drive gear. In some implementations, an inward end portion of the axle 140 includes splines 142 that matingly engage corresponding splines formed along a central opening of the axle drive gear 134. The outward end portion of the axle 140 also includes splines 144 that matingly engage corresponding splines formed in the hub 56. The gear 136 is an idler gear positioned between the motor gear 132 and axle drive gear 134 in gear meshing engagement with the motor and axle drive gears. The gear housing 124 includes a gear support shaft 138 that supports the idler gear 136 and about which the idler gear rotates.

The gear assembly 130 transfers rotational forces from the input/output shaft 126 to the axle 140 and from the axle to the input/output shaft. The idler gear 136 is configured to effectively decrease the motor-to-axle gear ratio between the motor gear 132 and axle drive gear 134. In other words, the idler gear 136 causes the axle drive gear 134 to rotate slower than the input/output shaft 126. The size and tooth-count of the idler gear 136 can be selected to provide a desirable motor-to-axle gear ratio, such as 16:1 in some embodiments. In some embodiments, the motor-to-axle gear ratio of the gear assembly 130 can be changed in situ by replacing one idler gear 136 having a first configuration with another idler gear having a second configuration. In one implementation, the gear housing 124 can include a removable cover 125 that overlays the motor and idler gears 132, 136 (see FIG. 3). Accordingly, a user of the rear axle assembly 40 can easily adjust the motor-to-axle gear ratio of the gear assembly 130 based on the type of application for or conditions in which the trailer 30 will be used such as the wheel size. For example, for high-speed applications, the motor-to-axle gear ratio desirably is higher compared to low-speed applications. Also, if the size of the tires 42 is adjusted, a user can easily modify the gear reduction ratio to compensate for the change.

As shown in FIG. 2, the gear housing 124 is coupled to the axle tube 50 with brackets or clamps 150. In some embodiments, the brackets 150 can be clam-shell type brackets that envelope the axle tube 50, while securing the gear housing 124 between opposing halves of the brackets. In other embodiments, other securing techniques can be used without departing from the essence of the invention. The gear housing 124 supports the electric motor 122 in a spaced-apart relationship with the axle tube 50. In certain embodiments, the electric motor 122 is retained above the axle tube 50. Moreover, the gear housing 124 is retained by the brackets 150 relative to the axle tube 50 such that the central axes (e.g., axes of rotation) of the input/output shaft 126 and axle 140 are parallel to each other and the axes of rotation of the gears 132, 134, 136.

As shown in FIG. 3, the portion 152 of the gear housing 124 that retains the axle drive gear 134 is positioned within the interior cavity 51 of the axle tube 50. In this manner, the axle drive gear 134 is alignable with the axle 140 positioned within the axle tube 50. Generally, the gear housing portion 152 extends through a hole or slot 154 formed in the axle tube 50 (the brackets 150 are omitted for convenience). Accordingly, the axle tube 50 is similar to conventional axle tubes, but includes the formation of a slot 154 for receiving the gear housing portion 152. The portions 156, 158 of the gear housing 124 that retain the motor gear 132 and idler gear 136, respectively, are positioned external to the interior channel 51 of the axle tube 50. The gear housing portions 152, 156, 158 enclose the motor, axle drive, and idler gears 132, 134, 136, respectively. Within the gear housing 124, the transitions between the gear housing portions 154, 156, 158 are open (see, e.g., FIG. 4).

Referring again to FIG. 3, the interior cavity 51 of the axle tube 50 defines a portion of at least one lubricant reservoir 160 extending from the end 54 of the tube to a stop 162 or seal. The lubricant reservoir 160 retains or stores a supply of lubricant. The axle drive gear 134 is positioned below the level of lubricant stored in the lubricant reservoir 160. Accordingly, the axle drive gear 134 is continually lubricated by the lubricant during actuation of the gear assembly 130. Additionally, because of the linear configuration of the idler gear 136 and motor gear 132 relative to the axle drive gear 134, splash lubrication of the idler and motor gears is enabled. Additionally, as lubricant contacts the gears, heat from the gears is transferred to the lubricant, which recirculates through the reservoir 160. Accordingly, the lubricant reservoir 160 acts as a heat sink or heat dissipating mechanism, as well as a lubricant source. Lubricant from the reservoir 160 is allowed to flow into the hub assembly 52 and hub 56 through the open end 54 of the axle tube 50. The lubricant contacts and lubricates the components of the hub assembly 52, such as the bearings, and acts as a heat transfer medium for dissipating heat generated by the hub assembly. The hub assembly 52 is sealed to the axle tube 50 to retain the lubricant in the lubricant reservoir 160 and hub assembly 52. In certain implementations, the gear housings 124 serve as a sealed splash lubrication reservoir such that a separate stop 162 is not needed.

As shown in FIG. 3, the axle tube 50 includes two separate lubricant reservoirs 160 each corresponding with a respective drive assembly 120 and hub assembly 52. The reservoirs 160 are accessible via a sealed conduit in the hubs 56 as discussed above. Replacement of the lubricant in the reservoirs 160, such as when the lubricant becomes degraded over time, is accomplished by removing the caps 46 in the hubs 56 that seal the conduit, draining the old lubricant out of the hubs through the conduits, and supplying fresh lubricant through the conduits and into the reservoirs. Lubricant can be drained from and supplied to the reservoirs 160 using any of various other configurations and techniques without departing from the essence of the invention. For example, sealable drains can be formed in the axle tube 50 instead of the hubs 56.

FIGS. 5 and 6 depict an alternative embodiment of a rear axle assembly 200. The rear axle assembly 200 includes components and features similar to rear axle assembly 40. For example, the rear axle assembly 200 includes a pair of electric drive assemblies 220 each configured to drive a respective wheel or hub assembly 270. The electric drive assemblies 220 each include an electric motor 222 coupled to a gear assembly retained by a gear housing 224. Each electric motor 222 drives a respective axle 240 via an associated gear assembly. The rear axle assembly 200 can be coupled to the frame rails 34 of a trailer or other passive vehicle in the same manner as rear axle assembly 40.

The rear axle assembly 200 also includes a rear axle tube 250. The rear axle tube 250, however, is different that the rear axle tube 50. Instead of being made of a continuous, one-piece tube like rear axle tube 50, the rear axle tube 250 includes multiple tube sections 252, 254, 256 coupled together to form the rear axle tube. The tube sections 252, 254 are first and second outer tube sections, respectively, and the tube section 256 is a middle tube section positioned between the first and second outer tube sections. Preferably, the tube sections 252, 254, 256 are coaxially aligned. However, in some embodiments, the tube sections 252, 254, 256 are not coaxially aligned, but can be axially offset with respect to each other as desired.

The tube sections 252, 254, 256 are coupled to each other via the gear housings 224. Each gear housing 224 is positioned between and coupled to the middle tube section 256 and a respective outer tube section 252, 254. To facilitate coupling to the gear housings 224, the first and second outer tube sections 252, 254 each include an inner flanged end 290 and the middle tube section 256 includes opposing flanged ends 292. The flanged ends 290, 292 can be formed as a one-piece unit with the respective tube section, or formed separate from the tube sections and fitted to the ends of the tube sections using pipe coupling techniques known in the art, such as welding.

The flanged ends 290, 292 are configured to be secured directly or indirectly to the gear housings 224. In some embodiments, the flanged ends 290, 292 are flush fitted to a face of the gear housings 124. In certain embodiments, the flanged ends 290, 292 include a plurality of apertures (not shown) corresponding with threaded apertures (not shown) formed in the gear housings 224. The tube sections 252, 254, 256 can be secured to the gear housings 224 by fasteners extending through the apertures in the flanged ends and matingly engaged with the threaded apertures in the housings. In certain implementations, a sealing member, such as gasket 280, can be positioned between the respective flanged ends 290, 292 of the tube sections 252, 254, 256 and the gear housings 224. The gaskets 280 can be any of various annular gaskets known in the art and can include apertures (not shown) corresponding with the apertures formed in the flanged ends of the tube sections and the gear housings. Any of various other methods and techniques, such as using a high pressure pipe fitting technique commonly known in the art, can be used to secure and seal the tube sections 252, 254, 256 to the gear housings 225 without departing from the essence of the invention.

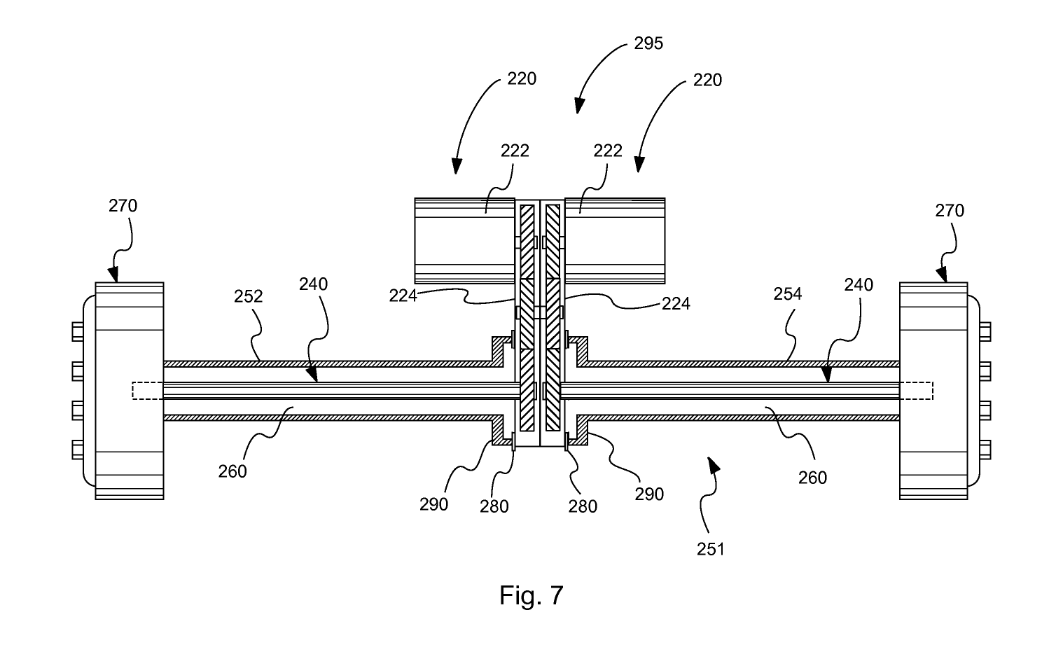

Although the rear axle tube 250 of the illustrated embodiment includes three tube sections 252, 254, 256, in other embodiments, the rear axle tube can include two or more than three sections without departing from the essence of the invention. For example, referring to FIG. 7, yet another alternative embodiment of a rear axle assembly 295 is shown. The rear axle assembly 295 is similar to rear axle assembly 200 except that the hollow axle tube 251 does not include a middle tube section 256. Instead, the gear housing 224 are coupled to each other in a back-to-back manner and the electric motors 22 extend outwardly away from the gear housings toward the respective hub assemblies 270. The gear housings 224 can be coupled to each other using any of various coupling techniques known in the art. In one implementation, fasteners can be passed through one gear housing 224 and tightened to the other gear housing. The outer tube sections 252, 254 and drive axles 240 are longer than the corresponding sections and drive axles of the rear axle assembly 200 to accommodate for the lack of a middle tube section.

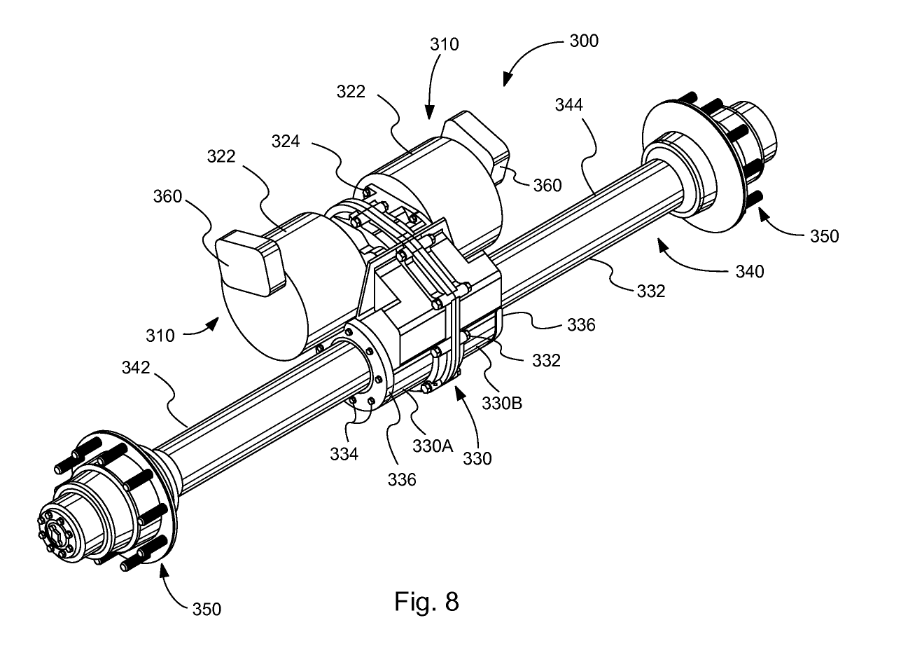

As shown in FIG. 8, a rear axle assembly 300 similar to the rear axle assembly 295 includes a single gear housing assembly 330 with two opposing gear housings 330A, 330B secured together in a back-to-back configuration. As with previous embodiments, the gear housings 330A, 330B each house a gear train including at least two gears. The gear housings 330A, 330B are similar to the housings 224 of the rear axle assembly 295, but are more robust to provide strength and rigidity to the assembly 300. With end plates (not shown) of the gear housings 330A, 330B mounted flush against each other, the housings are secured together with a plurality of fasteners 332 that extend through corresponding apertures in the housings and are tightenable against the gear housings. In the illustrated embodiment, the fasteners 332 each include a nut and bolt arrangement, but could include other types of fastener, adhesive, or bonding arrangements. The hollow axle tube 340 of the assembly 300 includes separate tube sections 342, 344 secured to the gear housings 330A, 330B, respectively. The inner ends of the tube sections 342, 344 include a flange 336 for facilitating a stable and strong connection to the gear housings 330A, 330B. More specifically, a plurality of fasteners 334 extend through the flanges 336 and into apertures formed in respective gear housings 330A, 330B, and are tightenable to secure the tube sections 342, 344 against the respective housings. The outer ends of the tube sections 342, 344 are secured to respective hub assemblies 350 such that the hub assemblies are rotatable relative to the respective tube sections.

The drive assemblies 310 of the rear axle assembly 300 each include an electric motor housing 322 that houses an electric motor (not shown). Attached to the electric motor housings 322 are respective electronic control modules 360 for transmitting operation commands and power to and from the electric motors. The electric motor housings 322 are secured to respective gear housings 330A, 330B via a plurality of fasteners 324 extending through respective gear housings and electric motor housings. The electric motors are secured to one gear of the gear train housed by respective gear housings via an input/output shaft that extends through respective apertures in the gear housings. Correspondingly, another gear of the gear train housed by respective gear housings is secured to a respective drive axle housed within a respective one of the tube sections 342, 344. The drive axles are secured to respective hub assemblies 350 to drive or be driven by the hub assemblies.

The rear axle assembly 300 also differs from the rear axle assembly 295 in that the gear trains, gear housings, and electric motors are not vertically aligned with the hollow axle tube 340 and drive axles. More specifically, the electric motor of the rear axle assembly 300 is vertically or laterally offset from the hollow axle tube 340 and drive axles. For example, although the electric motor input/output shafts and axes of rotation of the gears of the gear train remain parallel to the hollow axle tube 340 and drive axles, the input/output shafts of the electric motor are positioned either fore or aft of the hollow axle tube 340. Moreover, the gear trains housed within the gear housings 330A, 330B extend diagonally away from the hollow axle tube 340 as opposed to being directed above the tube. The above-described configuration of the rear axle assembly 300 conserves vertical space while still providing for the direct drive of a passive axle in a passive vehicle.

Although the gear housings 224 of the rear axle assembly 295 are coupled to each other, the gear trains housed within the respective housings actuate independently of each other. Further, although rear axle assembly 295 includes separate, back-to-back gear housings 224, in other embodiments, the back-to-back housings can be integrated into a single gear housing containing both gear assemblies. The single gear housing retains the gear trains separate from each other such that the gear trains actuate independently of each other.

In the multi-piece axle tube embodiments associated with FIGS. 5-7, the gear housings 224 (or gear housing) serve the dual function of housing a gear train (or trains) and providing a structural mounting surface and connection between the tube sections 252, 254, 256 of the hollow axle tube 250 and sections 252, 254 of hollow axle tube 251. In certain embodiments, the housings 224 and tube sections 252, 254, 256 are made from compatible high-strength materials, such as steel or other ferrous material.

The hollow interiors of the outer tube sections 252, 254 each define a respective lubricant reservoir 260 capable of storing lubricant for lubricating the gears of the gear assembly. The hub assemblies 270 and gear housings 224 act to seal the respective ends of the lubricant reservoirs 260.

Referring back to FIG. 2, the electric motors 122 of the drive assemblies 120 are electrically coupled to an inverter power control (IPC) unit 170 via respective power input/output lines 172. The power input/output lines 172 can include a single line or a plurality of separate lines. The IPC unit 170 receives power from and supplies power to the batteries 112 of the energy storage system 110 via a capacitor 180, which is an ultra-capacitor in some embodiments. The IPC unit 170 and capacitor 180 are in electric power communication via respective electric power input and output lines 182, 184.

The IPC unit 170 is configured to convert a DC power signal to an AC power signal and vice versa. The IPC unit 170 controls the actuation of the electrical motors 122 by supplying variable amounts of power to the motors. The motors 122 respond to the supply power by rotating the input/output shafts 126 at a rate corresponding with the amount of supplied power. The timing and amount of power supplied to the motors 122 is controlled by a power control unit (see, e.g., FIG. 5). The power control unit can be part of the IPC unit 170 or a separate unit.

The capacitor 180 is configured to increase the rate at which power can be supplied from the batteries 112 to the IPC unit 170. In certain implementations, the rear axle assembly 40 does not include a capacitor 170 such that energy is delivered to the electric motors 122 directly from the batteries 112. In other implementations, the rear axle assembly 40 does not include an energy storage system 110 such that the capacitor is the only energy storage mechanism. Although the rear axle assembly 40 shown includes a single IPC unit 170 and capacitor 180, in other embodiments, a rear axle assembly can include more than one IPC unit and capacitor.

As discussed above, the energy storage system 110 includes a plurality of batteries 112 each configured to store and supply energy for operation of the electric drive system 100, as well as other electrical components of the trailer. The batteries 112 can be electrically coupled to each other in series, parallel, or any other suitable configuration. The batteries 112 can be lithium-ion, lithium-phosphate, lithium-titinate, nickel metal hydride, or other suitable battery types. Although the rear axle assembly 40 shown includes a single energy storage system 110 with three batteries, in some embodiments, the rear axle assembly includes more than one energy storage system each with fewer or more than three batteries.

The batteries 112, IPC unit 170, and capacitor 180 are mounted to the trailer 30. In one embodiment, the batteries 112, IPC unit 170, and capacitor 180 are mounted to an underside of the floor 36 of the trailer proximate the electric drive assemblies 100. The floor 36 has been removed from FIG. 2 for convenience in showing the details of the rear axle assembly 40.

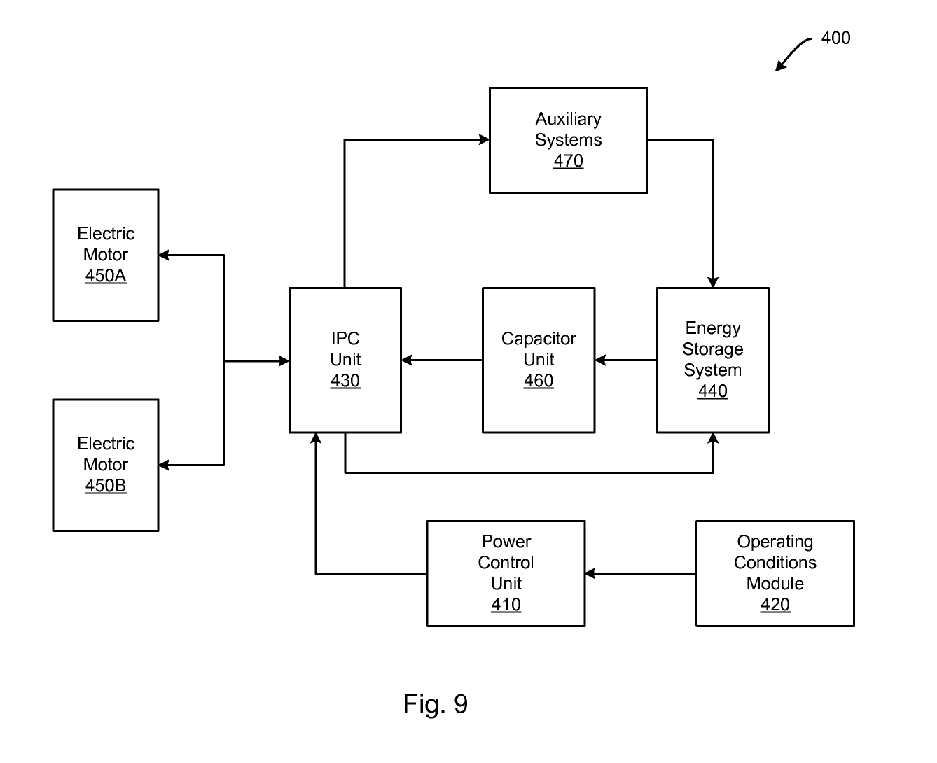

The electric drive system 100 is shown schematically as electric drive system 400 in FIG. 9. The description of the electric drive system 400 includes some corresponding elements of the system 100 as described above. Operation of the electric drive system 400 can be automatically controlled by the power control unit 410 according to the operating conditions of the trailer 30 and/or tractor 20 as supplied by the operating conditions module 420 or manually based on user input. More specifically, based on operating conditions and/or user input, the power control unit 410 commands the IPC unit 430 to operate the electric drive system 400 in one of several modes, such as drive assist mode, energy recovery mode, and auxiliary power mode. In the drive assist mode, the IPC unit 430 operates the electric motors 450A, 450B as motors. In the energy recovery mode, the IPC unit 430 operates the electric motors 450A, 450B as generators. Either separate from or during operation in the drive assist and energy recovery modes, the IPC unit 430 can control the supply of power to auxiliary systems of the trailer 30 in the auxiliary power mode.

According to predetermined operating conditions 420, such as during acceleration of the trailer 30, or manual input, the IPC unit 430 operates the electric drive system 400 in the drive assist mode. In the drive assist mode, the power control unit 410 commands the IPC unit 430 to receive electric power from the energy storage system 440, convert the power from a DC power signal to an AC power signal, and transfer the AC power to the electric motors 450A, 450B. The electric power from the energy storage system 440 can be delivered to the IPC unit 430 by a capacitor unit 460 configured to deliver power more quickly and efficiently than the energy storage system. In response to the power received from the IPC unit 430, the electric motors 450A, 450B rotate the input/output shafts of the motors (e.g., input/output shaft 126) at a rate corresponding with the level of power. Rotation of the input/output shafts is transferred to rotation of the axles 140, which in turn provides driving power to the wheels 42. When the electric motors 450A, 450B drive the wheels 42, the overall horsepower of the tractor-trailer system 10 is increased with an associated increase in the fuel efficiency and decrease in harmful exhaust emissions.

The power control unit 310 independently controls actuation of the electric motors 450A, 450B. Accordingly, the electric motors 450A, 450B can be operated at the same speed or different speeds depending on the operating conditions 420 of the system 10. For example, when driving along straight-aways, the speeds of the electric motors 450A, 450B are generally the same. However, when driving along corners, the outside wheel 42 is spinning at a faster rate compared to the inside wheel 42. Therefore, during turns, the power control unit 410 may command the IPC unit 430 to increase power to the electric motor driving the outside wheel and decrease power to the electric motor driving the inside wheel. The operating conditions module 420 can include wheel speed or other sensors and/or virtual sensors that provide the relative speed of the wheels.

According to predetermined operating conditions 420, such as during deceleration or braking of the trailer 30 or when the amount of energy stored by the energy storage system drops below a threshold, or manual input, the IPC unit 430 operates the electric drive system 400 in the energy recovery mode. In certain implementations, braking of the trailer 30 can be determined using an air brake signal from the trailer 30. In the energy recovery mode, the power control unit 410 commands the IPC unit 430 to operate the electric motors 450A, 450B as electric generators. The electric motors 450A, 450B recover energy from the rotation of the wheels 42, which is transferred from the axles 140 to the input/output shafts 126 of the motors via the gear assemblies 130. The recovered energy is received by the IPC unit 430, convert from an AC power signal to a DC power signal, and transfers to the energy storage system 440 for later use.

According to predetermined operating conditions 420, such as the activation of a trailer refrigeration unit (“reefer”), lighting, on-board communication devices, or other trailer auxiliary systems, the IPC unit 430 operates the electric drive system 400 in the auxiliary power mode. In the auxiliary power mode, which can occur concurrently with operation of the electric drive system 400 in the drive assist and energy recovery modes, the power control unit 410 commands the IPC unit 430 to transfer DC power from the energy storage system 440 via the capacitor unit 460 to one or more auxiliary systems 470 requesting power via an electrical outlet line (such as line 190 in FIG. 2). The auxiliary systems 470 can be configured to request power (e.g., turn on) automatically or in response to a manual request by a user of the trailer 30.

The configuration of the rear axle assembly 40 and electric drive system 100 described above facilitates simple and economically feasible retrofitting of existing passive vehicles, such as semi-trailers. As discussed above, the rear axle assemblies of conventional semi-trailers (as well as the passive axle assemblies of other vehicles, such as semi-tractors) include a hollow axle tube coupled to wheels via un-driven hub assemblies. In conventional rear and other passive axle assemblies, the un-driven hubs rotate freely about spindles secured to the axle tube. Passive or rear axle assemblies of conventional semi-trailers or semi-tractors are typically secured to the frame rails of a trailer and tractor, respectively, by suspension members and connecting rods similar to the suspension members 60 and connecting rods 62 of rear axle assembly 40.

According to one embodiment of a method for retrofitting an existing passive vehicle, the existing rear axle tube is dismounted from the passive vehicle by detaching the suspension members and connecting rods from the axle tube. The existing hub assemblies being secured to the rear axle tube are likewise dismounted from the passive vehicle with the axle tube.

In one implementation, the axle tube 50 is mounted to the existing passive vehicle in place of the existing axle tube. In certain instances, the axle tube 50 has dimensions similar to or the same as the existing axle tube. Accordingly, the new axle tube 50 is mounted to the passive vehicle by attaching the existing suspension members and connecting rods to the new axle tube in the same manner as the existing axle tube. The existing hub assemblies are replaced by dual axles 140 and new hub assemblies 52. The axles 140 and hub assemblies 52 can be pre-installed prior to the axle tube 50 being secured to the trailer or installed after the axle tube is secured to the passive vehicle. Similarly, the electric drive assemblies 120 can be secured to the rear axle tube 50 and axles 140 before or after the axle tube 50 is secured to the passive vehicle. Similarly, the wheels 42 can be pre-installed or post-installed, and the lubrication can be pre-injected or post-injected into the reservoir 160 via the hubs 56.

In an alternative implementation, such as when the quality, integrity, and/or reliability of an existing axle tube is assured, after being dismounted from the passive vehicle, the existing axle tube is retrofitted to include the slots 154 and if desired, the stops 162. More specifically, the slots 154 can be formed (e.g., cut) in the existing axle tube can at desired locations. The electric drive assemblies 120 can then be inserted into the slots 154 and secured to the existing tube using the brackets 150. Subsequently, axles 140 can be inserted into the existing axle tube to engage the gear assembly 130 of the electric drive assemblies 120. The hub assemblies 52 can then be secured to the existing axle tube in engagement with the axles 140 and lubrication can be injected into the hollow interior of the existing tube as discussed above. Finally, the wheels 42 can be secured to the hub assemblies 52.

Whether the passive vehicle is retrofitted with a new axle tube or a modified existing axle tube, the batteries 112 of the energy storage system 110 IPC unit 170, and capacitor unit 180 are mounted to the existing passive vehicle in electric communication with the electric drive assemblies 120. Desirably, the batteries 112, IPC unit 170, and capacitor unit 180 are mounted to the underside of the floor or frame of the existing passive vehicle in close proximity to the electric drive assemblies. A power output line from the IPC unit 170 can be coupled to a electrical power or fuse box of the existing passive vehicle, such that power for the auxiliary systems of the passive vehicle can be supplied by the newly mounted energy storage system 110. A power control unit (e.g., power control unit 410) and associated sensors (e.g., operating conditions module 220) can be mounted to the existing passive vehicle.

In semi-trailer applications, the entire assembly 40 can be self-contained on the semi-trailer such that the assembly, including the components of the electric drive and energy storage systems 100, 110 (including the operating conditions module 220), is operable independent of a tractor to which the semi-trailer is hitched. In this manner, operability of the electric drive and energy storage systems 100, 110 is maintained regardless of the type of tractor being used to pull the semi-trailer.

Alternatively or additionally, for semi-trailers, operation of the electric drive and energy storage systems 100, 110 is based at least partially on operating conditions received from the tractor to which the semi-trailer is hitched. In these implementations, a wireless signal transmitter can be connected to an on-board diagnostic (OBD) connector of the tractor and wirelessly transmit operating conditions, such as vehicle speed or throttle position, to the power control unit mounted on the trailer. In this manner, wired connections between the trailer and tractor are not required for operation of the electric drive systems 100, 110.

Although the above embodiments have been described in the context of a semi-trailer, the invention is not limited to such configurations. For example, in other embodiments, the electric drive system can be applied to any of various passive axles of passive vehicles as defined above. Moreover, although the illustrated embodiments have been described in relation to a rear axle assembly of a trailer, the elements of the assembly are equally applicable to front and intermediate axle assemblies of a trailer or any passive axle assemblies of other passive vehicle (e.g., the tag axle assemblies of tractors).

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An electric drive system for a passive vehicle having a pair of spaced-apart wheels, comprising:
a hollow axle tube positioned between the spaced-apart wheels;
first and second gear assemblies coupled to the hollow axle tube;
first and second electric motors respectively coupled to the first and second gear assemblies; and
first and second drive axles positioned within the hollow axle tube, the first drive axle comprising a first end portion coupled to a first of the spaced-apart wheels and a second end portion coupled to the first gear assembly, and the second drive axle comprising a first end portion coupled to a second of the spaced-apart wheels and a second end portion coupled to the second gear assembly;
wherein actuation of the first electric motor rotates the first drive axle and first wheel via the first gear assembly and actuation of the second electric motor rotates the second drive axle and second wheel via the second gear assembly.

2. The electric drive system of claim 1, wherein the hollow axle tube comprises first and second apertures, and wherein a portion of the first gear assembly is received within the first aperture and a portion of the second gear assembly is received within the second aperture.

3. The electric drive system of claim 2, further comprising first and second clamps each at least partially encircling the hollow axle tube and covering a respective one of the first and second apertures to retain the respective portions of the first and second gear assemblies within the first and second apertures.

4. The electric drive system of claim 1, wherein the hollow axle tube defines a lubricant reservoir containing a lubricant, and wherein at least one gear of the first and second gear assemblies is exposed in lubricant receiving communication with the lubricant in the lubricant reservoir.

5. The electric drive system of claim 1, wherein the first and second gear assemblies each comprise a plurality of gears each having an axis of rotation, and the first and second electric motors comprise a drive shaft, and wherein the hollow axle tube, axes of rotation, drive shafts, first drive axle, and second drive axle are parallel to each other.

6. The electric drive system of claim 5, wherein the first gear assembly is housed within a first gear housing and the second gear assembly is housed within a second gear housing, and wherein the first and second gear housings are fastened directly to the hollow axle tube.

7. The electric drive system of claim 1, wherein the first and second electric motors are positioned between the first and second gear assemblies.

8. The electric drive system of claim 1, wherein the first and second gear assemblies are positioned between the first and second electric motors.

9. The electric drive system of claim 1, wherein the hollow axle tube comprises a single continuous tube.

10. The electric drive system of claim 1, wherein the hollow axle tube comprises at least two interconnected tube sections.

11. The electric drive system of claim 10, further comprising a first gear housing in which the first gear assembly is housed and a second gear housing in which the second gear assembly is housed, the first and second gear housings being coupled to the at least two interconnected tube sections, and wherein a first tube section of the at least two tube sections is positioned between the first and second gear housings, the first gear housing being positioned between the first tube section and a second tube section of the at least two tube sections, and the second gear housing being positioned between the first tube section and a third tube section of the at least two tube sections.

12. The electric drive system of claim 10, further comprising a first gear housing in which the first gear assembly is housed and a second gear housing in which the second gear assembly is housed, the first and second gear housings being secured to each other in a back-to-back configuration, wherein a first tube section is secured directly to the first gear housing and positioned between the first gear housing and the first wheel and a second tube section is secured directly to the second gear housing and positioned between the second gear housing and the second wheel.

13. An electric drive system for a passive vehicle having a pair of spaced-apart wheels, comprising:
a hollow axle tube positioned between the spaced-apart wheels and secured to the trailer;
first and second gear assemblies coupled to the hollow axle tube, the first and second gear assemblies each comprising a plurality of gears rotatable about respective axes extending parallel to the hollow axle tube;
first and second electric motors respectively coupled to the first and second gear assemblies, the first and second electric motors each comprising an input/output shaft extending parallel to the hollow axle tube, the input/output shaft of the first electric motor being coupled to a first gear of the first gear assembly and the input/output shaft of the second electric motor being coupled to a first gear of the second gear assembly;
first and second drive axles positioned within the hollow axle tube and extending parallel to the hollow axle tube, the first drive axle comprising a first end portion coupled to a first of the spaced-apart wheels and a second end portion coupled to a second gear of the first gear assembly, and the second drive axle comprising a first end portion coupled to a second of the spaced-apart wheels and a second end portion coupled to a second gear of the second gear assembly, the second gears being positioned within the hollow axle tube; and
an energy storage system in electrical power communication with the first and second electric motors, the energy storage system supplying electrical power to at least one of the first and second electric motors in a drive assist mode and receiving electrical power from at least one of the first and second electric motors in an energy recovery mode.

14. The electric drive system of claim 13, wherein the input/output shafts of the first and second electric motors are substantially parallel to the first and second drive axles.

15. The electric drive system of claim 13, wherein the energy storage system comprises at least one battery and a capacitor in electrical power transmitting communication between the at least one battery and the first and second electric motors.

16. The electric drive system of claim 13, wherein the energy storage system is in electrical power communication with at least one auxiliary device of the passive vehicle in an auxiliary power mode.

17. The electric drive system of claim 13, wherein the passive vehicle is a semi-trailer, and wherein the energy storage system is secured to and contained entirely within the confines of the semi-trailer.

18. The electric drive system of claim 13, wherein the energy storage system comprises a power control unit configured to independently control actuation of the first and second electric motors.

19. A method for retrofitting an existing passive vehicle comprising a passive axle assembly having an existing hollow axle tube coupled to the vehicle via a suspension assembly, the method comprising:
removing the existing hollow axle tube from the suspension assembly;
providing an electrically driven axle assembly comprising a modified hollow axle tube substantially similar to the existing hollow axle tube, first and second gear assemblies coupled to the modified hollow axle tube, first and second electric motors respectively coupled to the first and second gear assemblies, and first and second drive axles positioned within the hollow axle tube, the first drive axle comprising an end portion coupled to the first gear assembly, and the second drive axle comprising an end portion coupled to the second gear assembly, wherein actuation of the first electric motor rotates the first drive axle via the first gear assembly and actuation of the second electric motor rotates the second drive axle via the second gear assembly; and
coupling the modified hollow axle tube to the suspension assembly.

20. The method of claim 19, wherein providing the modified hollow axle tube comprises forming two slots into the removed existing hollow axle tube, and wherein providing first and second gear assemblies coupled to the modified hollow axle tube comprises inserting at least one gear of the first gear assembly within one of the two slots and inserting at least one gear of the second gear assembly within the other of the two slots.
